(19) United States
(12) Patent Application Publication
(10) Pub. No.: US 2023/0132330 A1
(43) Pub. Date: Apr. 27, 2023

(54) ADVERSARIAL IMAGE GENERATOR TO IMPROVE DNN IMAGE SEGMENTATION MODEL ROBUSTNESS FOR AUTONOMOUS VEHICLE

(71) Applicant: EMC IP Holding Company LLC, Hopkinton, MA (US)

(72) Inventors: Hugo de Oliveira Barbalho, Rio de Janeiro (BR); Pablo Nascimento da Silva, Rio de Janeiro (BR); Roberto Nery Stelling Neto, Rio de Janeiro (BR)

(21) Appl. No.: 17/451,793

(22) Filed: Oct. 21, 2021

(51) Int. Cl. G06N 3/04; G06K 9/62; G06K 9/00

(52) U.S. Cl. CPC G06N 3/0454; G06K 9/6261; G06K 9/00791

(57) ABSTRACT

One example method includes deploying a discriminator, where the discriminator is trained to recognize an adversarial image received by the discriminator as adversarial, and the adversarial image is generated based upon an original image, the adversarial image including a perturbation that cannot be detected by a human eye but which is effective to deceive an image segmentation model to misclassify the original image, receiving, by the discriminator, an image captured by an autonomous vehicle, and determining, by the discriminator, whether the image received from the autonomous vehicle is adversarial.

### FIELD OF THE INVENTION

Embodiments of the present invention generally relate to addressing security vulnerabilities in pre-trained machine learning models. More particularly, at least some embodiments of the invention relate to systems, hardware, software, computer-readable media, and methods for the use of adversarial attacks on pre-trained machine learning models to identify and resolve security vulnerabilities.

### BACKGROUND

There has been an increase in machine learning models, such as deep learning models, that require large amounts of data and computational resources for training. The offering of services for fine-tuning pre-trained models using a transfer learning method has been primarily publicized as the solution for the lack of data and computational resources problem in the training of deep learning models. However, the centralized nature of transfer learning makes the pre-trained model an attractive and vulnerable target for attackers since the pre-trained models are usually publicly available, or easily accessible.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an approach for implementing an untargeted Fast Gradient Sign Method (FGSM) attack.

FIG. 2 discloses aspects of an approach for implementing a targeted FGSM attack.

FIG. 3 discloses an example of an FGSM attack for image segmentation.

FIG. 4 discloses a transformation of an original image to create an adversarial target.

FIG. 5 discloses an example of a defense pipeline that includes a discriminator.

FIG. 6 includes a table with experimental results.

FIG. 7 discloses results for an optimized FGSM (Opt-FGSM) attack.

FIG. 8 discloses results for a non-optimized FGSM attack.

FIG. 9 discloses an example computing entity operable to perform any of the disclosed methods, processes, and operations.

### DETAILED DESCRIPTION OF SOME EXAMPLE EMBODIMENTS

Embodiments of the present invention generally relate to addressing security vulnerabilities in pre-trained machine learning models. More particularly, at least some embodiments of the invention relate to systems, hardware, software, computer-readable media, and methods for the use of adversarial attacks on pre-trained machine learning models to identify and resolve security vulnerabilities.

In general, example embodiments of the invention may be particularly useful in addressing vulnerability issues in transfer learning settings when using public pre-trained models to train DNN (Deep Neural Network) models for image segmentation in resource-constrained devices, although the scope of the invention is not limited to such applications. Thus, example embodiments may comprise a defense pipeline that employs a discriminator, which may take the form of an ML (Machine Learning) model that is responsible for distinguishing genuine images from adversarial images. Embodiments may also provide a method for generating adversarial images that may be leveraged to train the discriminator model in the pipeline so that the discriminator is able to distinguish between real images and adversarial, that is, malicious, images.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that vulnerabilities in publicly accessible models used for transfer learning may be reduced or eliminated. Advantageously, an embodiment may enable transfer learning processes to take place without the teacher model being compromised by a bad actor. Advantageously, an embodiment may help to reduce or eliminate the vulnerability of an image segmentation ML model to attacks involving image perturbations. Advantageously, an embodiment may help to reduce or eliminate the likelihood that the operation of an AV (autonomous vehicle) will be compromised by the introduction of image perturbations. Various other advantageous aspects of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Example Problems Relating to Some Embodiments

As noted earlier herein, technical problems associated with using a pre-trained model to train ML models in a transfer learning setting can include exposing Al/ML-based applications to vulnerabilities.

For example, traditional DNN models designed for image segmentation are vulnerable to attacks that create small perturbations in the input image to fool the image segmentation model. Particularly, ML models trained for image segmentation tasks are vulnerable to malicious attacks that modify the input data to fool the ML model segmentation output. A typical example of such an attack is to hide a single class, such as a vehicle or pedestrian for example, from the segmentation. This can cause a catastrophic accident since the AV will make decisions based on such incorrect, or adversarial, segmentation. Thus, example embodiments provide a method that can detect whether an image is genuine or adversarial.

As another example, the centralized nature of transfer learning approaches and systems makes them an attractive and vulnerable target for attackers since the pre-trained models are usually publicly available, or easily accessible. DNN models are both time-consuming and data-intensive. In many applications, these characteristics often make the training of a model from scratch impractical. In these cases, a transfer learning process may be used to overcome these issues. However, the centralized nature of transfer learning makes it an attractive and vulnerable target for attackers, since the attack designed for the central model, that is, the public model, can be applied to the student model, that is, the private model.

As a final example of technical problems with which example embodiments may be concerned, existing methods to create adversarial images are designed for image classification and produce too much noise when adapted to image segmentation in an unsophisticated way. Particularly, traditional methods used to create adversarial images, such as FGSM (Fast Gradient Sign Method), are designed for image classification. To be adapted for the image segmentation task, more iterations of FGSM would have to be executed. Since this method controls the noise level in the image by running only a few iterations, the resultant adversarial images are prone to be classified, possibly incorrectly, as adversarial. Thus, example embodiments may provide a robust discriminator that may be trained against adversarial images that would constitute effective, and hard to detect, attacks. Thus, embodiments may provide a method for creating adversarial images that can be used to simulate an effective attack on an ML model.

### B. Overview

Nowadays, a large variety of applications employ image segmentation to support decision-making processes. For example, an algorithm that automatically identifies the human body parts in MRI (magnetic resonance imaging) helps doctors identify diseases. Image segmentation can also be utilized as the input of other algorithms, as is the case of autonomous vehicles (AV), where the segmentation, or image segments, is later used by the car to decide how to drive on a given road. The time, cost, and effort, to train an ML model for image segmentation from scratch in a resource-constrained device such as AV are prohibitive. To mitigate that problem, transfer learning (TL) aims to build useful models for a task by reusing a model pre-trained for a similar but distinct task, or for the same task but with a different data distribution. Such pre-trained models are typically made available by way of a public source, for example, image segmentation tasks may access available public datasets such as Cityscapes for example.

In view of the aforementioned considerations, technical solutions include example embodiments that may provide methods for addressing the vulnerability issues presented in transfer learning settings when using public pre-trained models to train DNN models for image segmentation in resource-constrained devices. Particularly, example embodiments may provide a defense pipeline that relies on a discriminator, which may take the form of an ML model, responsible for distinguishing genuine images from adversarial images. As well, example embodiments may embrace methods for generating adversarial images that can be used to train the discriminator model described in the pipeline so that the discriminator model can identify adversarial images that may compromise the operation of equipment and systems associated with a student model that was created and/or trained based on a public DNN model.

### C. Background

As noted earlier herein, example embodiments may be particularly useful in contexts involving transfer learning. This section discusses how transfer learning is used to train a DNN, its benefits, and its vulnerability. Following that, a discussion is provided concerning how such vulnerability is exploited by attackers.

C.1 Transfer Learning

Deep Neural Networks (DNN) have been widely and successfully employed in various applications, such as image classification, speech recognition, and image segmentation. Training a deep neural network model is both time-consuming and data-intensive. In many applications, these characteristics often make the training of a model from scratch impractical. Transfer learning may be used to overcome these issues.

Transfer learning is a machine learning research area specialized in building useful models for a task by reusing a model from a similar but distinct task, or the same task but with a different data distribution. In practice, generally, a handful of well-tuned and intricate centralized models, which may also be referred to as a ‘teacher’ model, pre-trained with large datasets are shared on public platforms. Then, individual users use those models and further customize them to create accurate models, also referred to as a ‘student’ model, for specific tasks. The most common approach to perform transfer learning in deep learning is using the pre-trained model as a starting point and fine-tune the model for a specific task until it achieves a good accuracy using only very small and limited training data.

The centralized nature of transfer learning makes it an attractive and vulnerable target for attackers. Typically, most teacher models are hosted and maintained on popular platforms, such as Azure, Amazon Web Services, Google Cloud, and GitHub, and access to these models is publicly available. So, since the highly tuned centralized model is publicly available, an attacker can readily exploit that characteristic to create adversarial examples to fool the model, thus creating security and operational problems.

C.2 FSGM-based Attack for Image Classification

A traditional attack directed at DNNs for image classification is the Fast Gradient Sign Method (FGSM) attack. This attack relies on adversarial samples, that is, samples specifically tailored from a given input of the neural network so that the samples can be misclassified by the DNN.

In general, attacks directed to a DNN may be divided into two categories. The first category is targeted attacks. Targeted attacks focus on changing the classification output of a model, given a particular input of the neural network, to be a specific output. For example, the attack may result in the DNN identifying an image of a cat, the input to the model, as being an image of a dog, the model output. Thus, the input class is a Lu cat, and the attack changes the model output to a specific class, that is, a dog. Another example is when an attacker changes the DNN so that the model identifies the face of the attacker authorized to access a given device.

Another category of attack on a DNN is untargeted attacks. An untargeted attack aims to change the classification for a given input to any class, rather than to a specific class, different from the original one, for example, malfunctioning any application that leverages neural networks.

Attacks may also be classified according to the access of the model internal information. For example, a white-box attack assumes the attacker has full access to the internals of the deep neural network. That is, the attacker knows the weights and architecture of the student model network. As another example, a black-box attack is one in which the attacker has no access to the internals of the target DNN, but the attacker can query the target DNN to obtain information.

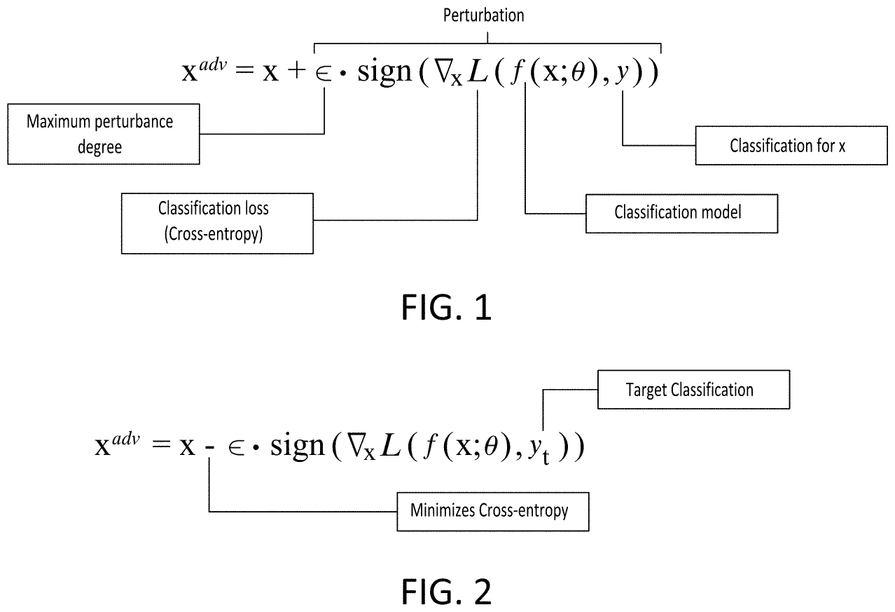

An FGSM attack is a white-box attack and can be either targeted or untargeted. The FGSM attack uses the gradients of the neural network to create an adversarial sample. For the untargeted version of FGSM attack, the goal is to fool the model to misclassify the image as any class different from the original one. The equation in FIG. 1 shows how the gradient is used in this case. Given the DNN classification f(x; θ), the ground truth y, and a loss function L, is computed the gradient of the loss with respect to the input x. This gradient indicates in which direction each pixel of the image should be changed to maximize the loss, that is, to make the classification f(x; θ) different from the ground truth y. To avoid a large perturbation, only the sign of the gradient is taken into consideration and is multiplied by a maximum perturbance degree E. The purpose in avoiding a large gradient is that the change may be perceptible by a human. Thus, the aim of the attack may be to make the gradient sufficiently large to fool the model, but not so large as to be perceptible by a human, since the human would then be able to perceive that an attack had been made.

For the targeted version of FGSM attack, the goal is to fool the model to misclassify the image as a specific class (target class). FIG. 2 shows how the gradient is used in this case. Given the DNN classification f(x;θ), the target classification yₜ, and a loss function L, the gradient of the loss is computed with respect to the input x. This gradient indicates in which direction each pixel of the image should be changed to maximize the loss, but here the goal is to minimize the loss, that is, to make the classification f(x;θ) equal to the target class yₜ. Thus, the optimization takes the opposite direction of the gradient. To avoid a large perturbation, such as may be perceptible by a human, only the sign of the gradient is taken into consideration and is multiplied by a maximum perturbance degree e.

C.3 FSGM-based Attack for Image Segmentation

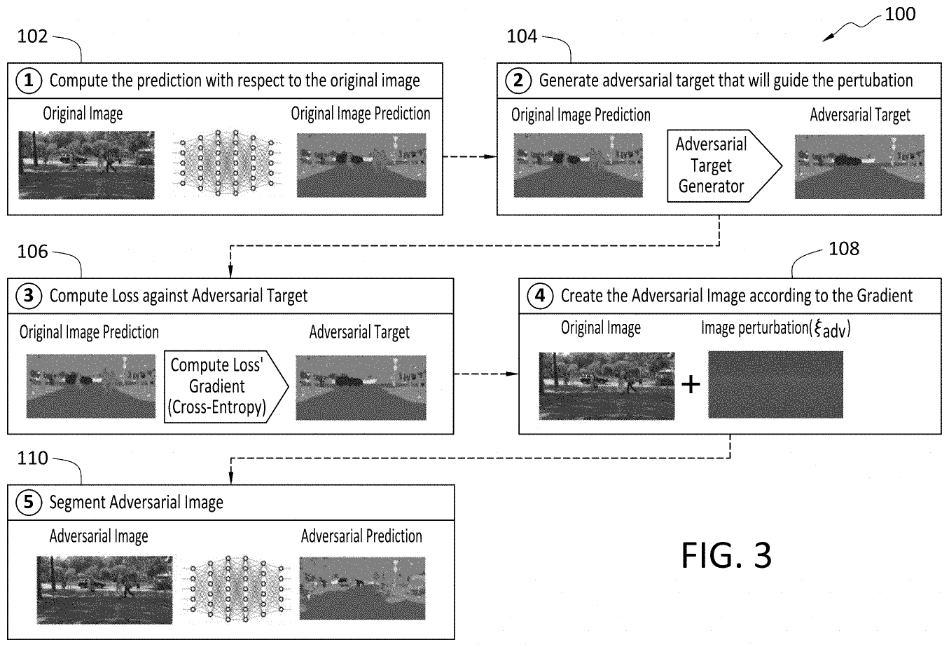

This section concerns FGSM attacks on image segmentation DNNs. As in attacks on DNN for image classification, attacks on DNN that perform image segmentation aim to perturb the original image to fool its respective inference. In this case, though, the new inference may be the same image, but with hidden objects or making a static inference. Traditionally, in a FGSM attack, the adversarial image is created over an optimization process that perturbs the original image to change the classification of the Lu original image to a new/different classification. This new classification can be either a given adversarial target classification (Target FGSM) or just change the original classification (Untargeted FGSM). For image segmentation, the target FGSM attack is more common. An example pipeline 100 for a targeted FGSM attack is disclosed in FIG. 3.

In general, the pipeline 100 concerns a situation in which an original image (see ‘Original Image’ at step 1), showing pedestrians walking across a street, is input into a model which generates an Original Image Prediction based on the original image. The Original Image Prediction is then used to create an Adversarial Image which appears, to the human eye at least, to be the same as the Original Image. However, the Adversarial Image is sufficiently different that when used as input to the model, an Adversarial Prediction is generated that does not include the pedestrians, as can be seen by comparing the Original Image Prediction with the Adversarial Prediction. Thus, the perturbation has effectively removed the pedestrians from the prediction generated by the model.

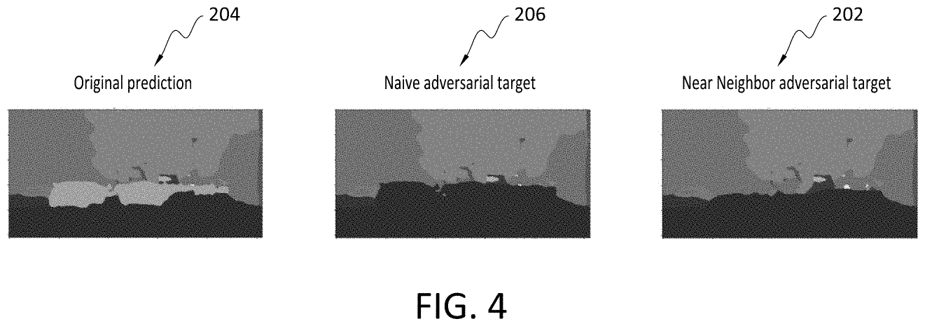

In more detail, the pipeline 100 starts with computing 102 the segmentation for the original image in step 1, and then at step 2, the adversarial target classification is created 104 to guide the optimization process that will create an adversarial image, that is, a perturbation. The adversarial target classification can be generated in different ways depending on the goal of the attack, and two ways are highlighted here. The first one is a naïve generation that simply replaces all pixels classified as source class to be a pixel of a target class. The second one is the NearNeighbor generation which operates Lu to replace a source class pixel by the class of the NearNeighbor pixel that has a different class. Note that, in FIG. 4, the NearNeighbor transformation 202 of the original prediction 204 is softer than the naïve transformation 206 of the original prediction 204.

With continued reference to FIG. 3, once the adversarial target is defined, step 3 of the pipeline 100 is to compute 106 the loss, that is, cross-entropy, between the original prediction and the adversarial target. Then, in step 4, a perturbation is calculated 108 following the loss gradient, and an adversarial image is created. The adversarial image can then, in step 5, be input 110 to the model to generate an adversarial prediction.

The pipeline 100 can be executed iteratively, and with more iterations, the perturbation becomes bigger. Also, note that while image classification attacks usually require one iteration, image segmentation attacks require a large number of iterations due to the complexity of the problem.

### D. Aspects of Some Example Embodiments

Example embodiments may demonstrate that adversarial attacks based on pre-trained models in transfer learning settings and designed for image classification tasks can be successfully adapted and applied to image segmentation problems. As well, embodiments may provide a discriminator-based defense pipeline to improve the robustness of an image segmentation model. Additionally, example embodiments are directed to a method to generate adversarial images that may be used to train the discriminator to differentiate adversarial (malicious) images from genuine (authentic) images.

In more detail, example embodiments may provide a pipeline to improve the robustness of a DNN model for the image segmentation task for resource-constrained devices like autonomous vehicles. This pipeline leverages a machine learning based discriminator that distinguishes genuine images from adversarial images. As well, example embodiments may provide a method to generate adversarial images to train the discriminator of the pipeline. An adversarial image generator according to example embodiments may operate, such as in an FGSM attack mode, to generate adversarial images with few perturbations.

D.1 Discriminator-Based Defense Pipeline

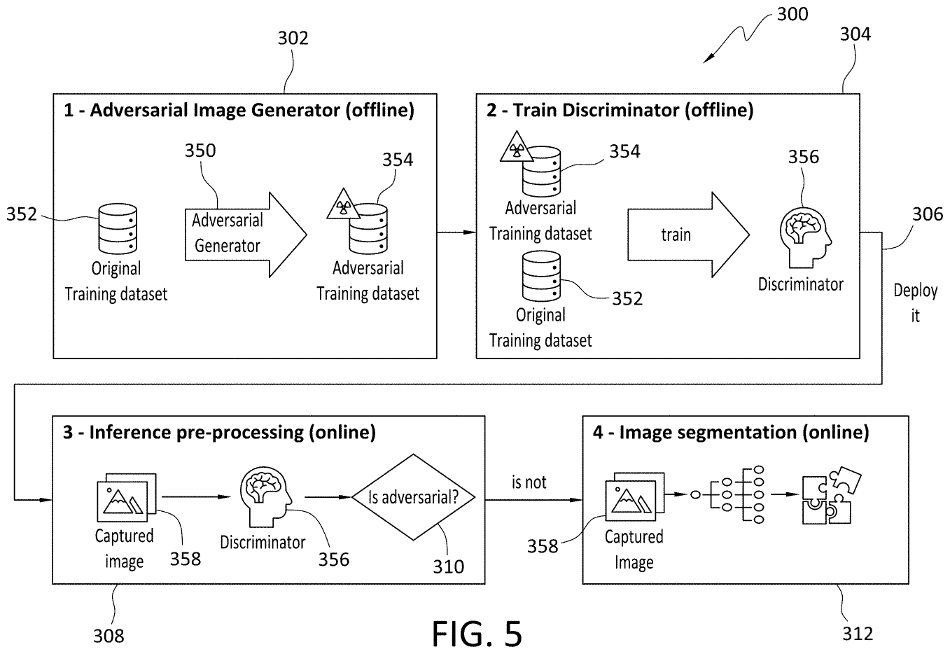

An example discriminator-based defense pipeline is split into 4 operations, two of which may be performed offline, and two of which may be performed online, as disclosed in the example method 300 of FIG. 5.

The method 300 may begin with the, possibly offline, generation 302 by an adversarial generator 350 of adversarial images over, that is, based on, the original training dataset 352 using a method that aims to fool a DNN model. In an image segmentation task, this approach may create a relatively small perturbation, or noise, relative to an original image, or set of images, to produce adversarial samples that may comprise elements of an adversarial training dataset 354. This perturbation may be large enough to fool the DNN output but small enough to not be perceptible by human eyes.

After the adversarial images have been generated 302, the adversarial images and original images may be used to train 304 an Al/ML-based discriminator 356 to distinguish the original images from the adversarial images. After the training 304 has been completed, the discriminator 356 may be deployed 358 to an operating environment. For example, the discriminator 356 may be employed in an environment that includes a teacher model and/or a student model, and the discriminator 356 may be used to check images before they are employed by the teacher model and/or the student model.

Once the discriminator has been deployed 306, the method 300 may perform an inference pre-processing operation 308. This operation 308 may be performed online, that is, while the discriminator is in a deployed state. Particularly, before an image 358 captured by, for example, an AV (autonomous vehicle), goes through inference, that image passes through the discriminator 356 trained at 304. In some embodiments, only images classified as ‘original’ pass to the inference operation. Thus, at 308, one or more captured images 358 may be passed to the discriminator 356, now trained, and the discriminator 356 may determine 310, based on its training, whether the captured image 358 is an adversarial image or not.

Finally, if the captured image 358 is determined 310 to not be an adversarial image, that is, the captured image 358 is classified as an original image, the pipeline may then perform, possibly online while images are being captured, an image segmentation 312 on the captured image 358. Thus, example embodiments of a pipeline, that is, the method 300, may prevent an Al/ML-based application, such as may be deployed on an AV, from making incorrect decisions when suffering an adversarial attack on the image segmentation process, or the image segments. For example, a lane detection application that relies on an image segmentation DNN model may alert the driver that this function, that is, the ability to provide the lane detection function, is not available when an adversarial image is detected during image segmentation and/or in the image segments.

D.2 Adversarial Image Generator

Attacks directed at DNNs aim to produce perturbations over an image to fool the DNN in order to induce the DNN to misclassify the image, or create a different segmentation, as discussed earlier herein. FGSM attack is a traditional attack to DNN that changes the original image, that is, the variable of the problem, by solving an optimization problem that minimizes the loss between the DNN classification, such as a cat for example, and the adversarial target class, such as a dog for example. As discussed earlier herein, this attack can also be applied to image segmentation.

Recall that an attack should not create too much noise. For the image segmentation task, however, an FGSM attack requires multiple iterations, and with more iterations comes more substantial noise over the original image. Thus, example embodiments embrace improvements in the FGSM attack to create adversarial images for the image segmentation task by including an additional term in the optimization function that minimizes the dissimilarity between the original image and the adversarial image. By reducing the dissimilarity, the adversarial image may fool the DNN model, while also being imperceptible to the human eye.

To control the perturbation level, example embodiments may implement an optimization method that uses a loss function that combines cross-entropy and a dissimilarity function called DSSIM (Structural Dissimilarity). The cross-entropy minimizes the difference between adversarial image classification and target classification, and the DSSIM minimizes the structural difference between original and adversarial images. DSSIM is a distance metric derived from SSIM (Structural SIMilarity), and its main idea is that humans are sensitive to structural changes in an image, which strongly correlates with their subjective evaluation of image quality. The basic form of SSIM compares three aspects of the two image samples: luminance (I); contrast (c); and, structure (s). To infer structural changes in an image, DSSIM captures patterns in pixel intensities, especially among neighboring pixels.

The optimization problem posed by example embodiments of the invention is defined as follows: min L(Z_{adv},θ), yₜ)+λ*DSSIM(X_{adv},X), where L is the cross-entropy loss, λ is a constant that sets the importance of dissimilarity in the optimization, X_{adv}∈R^{nm} is the variable that represents the adversarial image, yₜ is the target segmentation, and X∈R^{nm} is a constant that represents the original image. Note that X_{adv}=X before the optimization and this problem can be solved iteratively by using traditional algorithms like Adadelta optimizer implemented in Pytorch.

Alternatively, some embodiments may add a constraint to this optimization problem to limit theamount of allowed noise (ρ). This constraint can be expressed as:

DSSIM(X_{adv},X)≤ρ.

As well, operations 106 and 108 of the FGSM attack for image segmentation described in FIG. 3 may be replaced by this optimization problem. In the computational results section herein, it can be seen that the optimization method according to example LU embodiments may generate images that can fool both teacher and student models by hiding vehicles in the image segmentation with small perturbations. This computational result is important to show that the optimized FGSM according to some example embodiments may be used to train a discriminator, since an adversarial image with too much noise may be easily identified as adversarial. Thus, the attacker will prefer the method that can fool the model and is imperceptible to human eyes.

### E. Further Discussion

As will be apparent from this disclosure, example embodiments may provide a variety of advantageous aspects. One such aspect is a defense pipeline that may employ a discriminator, such as an ML model for example, that is operable to distinguish genuine images from adversarial images. As well, a defense pipeline according to some embodiments may operate to train a ML-based discriminator to distinguish genuine images from adversarial images. Then, this discriminator may be used as a pre-processing step for the inference phase, which aims to identify whether the input image is genuine or not.

Another advantageous aspect of some example embodiments is a method for generating adversarial images that may be used to train a discriminator, example embodiments of which are disclosed herein. As well, embodiments of the invention may provide a method to generate a dataset of adversarial images to train a discriminator. A dataset with adversarial images may be used by the defense pipeline to make a DNN trained for image segmentation task more robust. This method may be more effective than traditional FGSM attacks to fool student models trained for image segmentation tasks under transfer learning settings.

### F. Example Computational/Experimental Results

This section discloses an evaluation of the robustness of transfer learning for an image segmentation task. Particularly, an aim of example embodiments may be to evaluate how robust a student model is against adversarial attacks in a transfer learning setting, more specifically, to understand how robust student models are against attacks designed for the teacher model used to create and/or train the student model.

All the images in the test set were re-scaled to 512×1024 format. Note that the complexity of the attack increases with the size of the image. The experiments were run on a Dell PowerEdge C4140 server, using Ubuntu and a Nvidia Tesla V100 GPU. Three metrics were used to evaluate the model and its robustness against attacks: (i) accuracy, before and after the attack; (ii) targeted class accuracy, to measure the effectiveness of targeted attacks; (iii) and, image dissimilarity to measure the number of pixels changed as a result of the attack.

In general, the experiments were performed to evaluate whether white-box attacks, such as FSGM and Optimized FGSM, designed for a teacher model fool its student model. More specifically, experiments compared two attacks: (1) the original FGSM; and, (2) the Optimized FGSM (Opt-FGSM) according to some example embodiments, as described in the discussion of FIG. 3 above. For each training image, an adversarial image was created using an attack for the teacher model, and an evaluation performed of the robustness of the student model over this adversarial image.

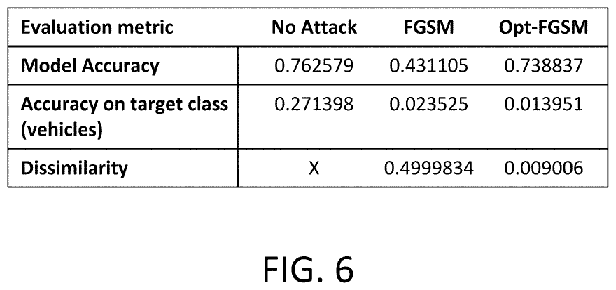

The experimental results show that the model accuracy decreases to a large extent when traditional FGSM is used. The same does not happen when the optimization process, according to some example embodiments, is applied to the FGSM framework. Rather, Opt-FGSM shows a slight decrease in the model accuracy, from 0.762579 (no attack) to 0.738837 (Opt-FGSM) which means that the attack seems to affect only the targeted class, vehicles in this example. The following metrics, see the table in FIG. 6, confirm this. For example, the accuracy of the target class shows that all attacks are effective, reducing the accuracy of cars from 0.271 to 0.023525 and 0.01395.

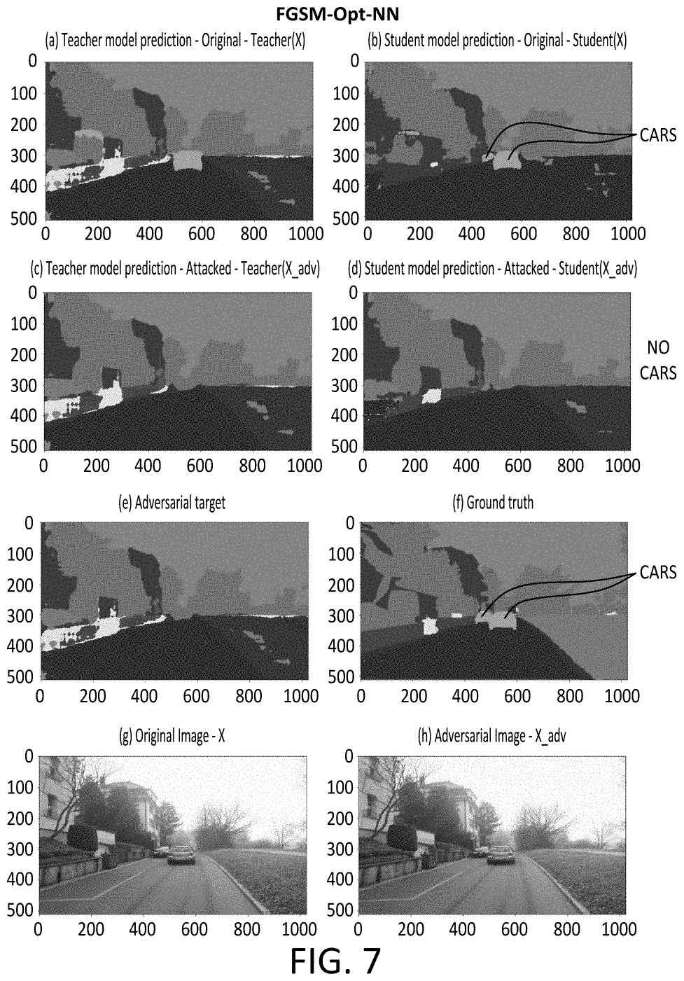

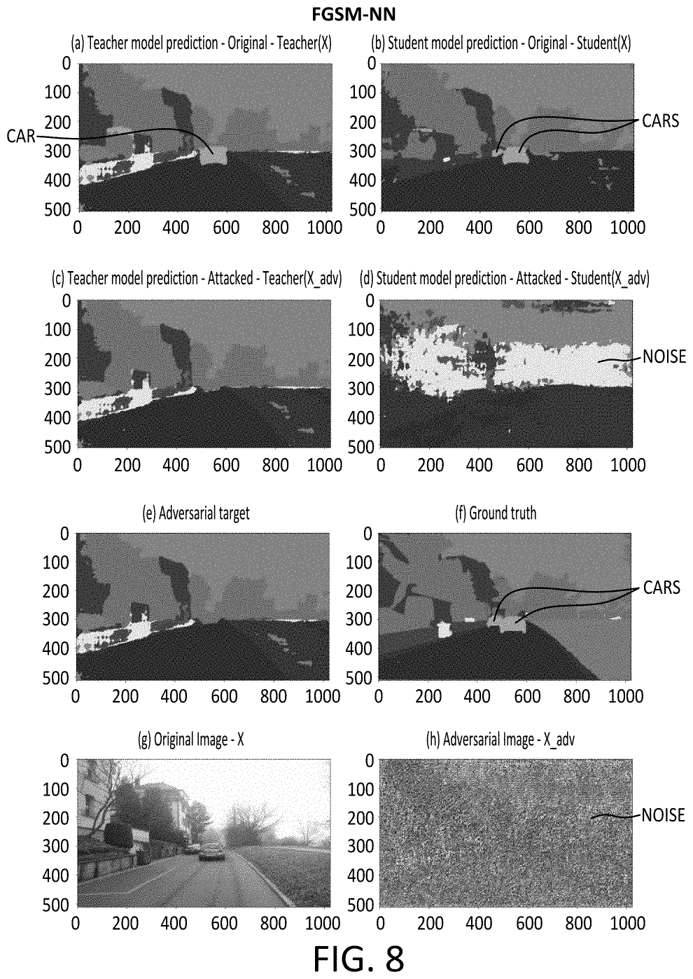

Another important metric is the dissimilarity between the original image and the adversarial image, where the lower the dissimilarity, the better. FGSM, without any optimization, produced images with significant noise, as can be seen in FIG. 8. However, when the optimization Opt-FGSM is applied, the resulting adversarial image is quite similar to the original image, as shown in the bottom two pictures of FIG. 7 (showing results of the application of Opt-FGSM), and in the last row of the table in FIG. 6, where the dissimilarity value produced by Opt-FGSM is very close to zero.

With continued reference to FIG. 7, there are disclosed the results of applying the Opt-FGSM attack to an image from the ‘foggy driving’ dataset. In FIG. 7, the original image is displayed in the last row first column (g), while the adversarial image is depicted in the last row second column (h). As can be seen, those two images are quite similar to each other. The first row second column (b) presents the original prediction of the student model. This model successfully predicts the two cars in the center of the image. When the same model is used to predict the adversarial image, depicted in the second row second column (d), it can be seen that both cars disappear from the prediction.

FIG. 8 provides similar images showing the results for the traditional FGSM attack. As can clearly be seen, for example, in the last row, the adversarial image (h) is unrecognizable and easily distinguished, even by the human eye, from the original image (g). Thus, differently from the conventional FGSM attack, the Optimized FGSM employed by embodiments of the invention may be used to train a discriminator, example embodiments of which are also disclosed herein, since the Optimized FGSM is more efficient and produces less noise, relative to the conventional FGSM attack, even when applied to the student model.

It is noted that the experimental results disclosed in FIGS. 7 and 8 were achieved by application of a method, according to some example embodiments, to a dataset referred to as ‘the foggy dataset,’ further details about which are disclosed in Sakaridis, C., D. D. & Van Gool, L. Semantic Foggy Scene Understanding with Synthetic Data. Int J Comput Vis 126, 973-992 (2018) Further information can be found at: http://doi.org/10.1007/s11263-018-1072-8.

### G. Example Methods

It is noted with respect to the example methods of FIGS. 3 and 5 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent Lu performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### H. Further Example Embodiments

Following are some further example embodiments of the invention. These are presented only by way of example and are not intended to limit the scope of the invention in any way.

Embodiment 1. A method, comprising: deploying a discriminator, wherein the discriminator is trained to recognize an adversarial image received by the discriminator as adversarial, and wherein the adversarial image is generated based upon an original image, the adversarial image including a perturbation that cannot be detected by a human eye but which is effective to deceive an image segmentation model to misclassify the original image; receiving, by the discriminator, an image captured by an autonomous vehicle; and determining, by the discriminator, whether the image received from the autonomous vehicle is adversarial.

Embodiment 2. The method as recited in embodiment 1, wherein the adversarial image is generated using an optimized FGSM attack.

Embodiment 3. The method as recited in embodiment 2, wherein the adversarial image exhibits less perturbation than an adversarial image generated by a non-optimized FGSM attack.

Embodiment 4. The method as recited in any of embodiments 1-3, wherein when the image received from the autonomous vehicle is determined not to be adversarial, performing an image segmentation process on the image received from the autonomous vehicle, and the image segmentation process results in creation of image segments.

Embodiment 5. The method as recited in embodiment 4, wherein the autonomous vehicle uses the image segments to navigate.

Embodiment 6. The method as recited in any of embodiments 1-5, wherein the image segmentation model is a deep neural network model.

Embodiment 7. The method as recited in any of embodiments 1-6, wherein the discriminator uses a machine learning process to create the adversarial image.

Embodiment 8. The method as recited in any of embodiments 1-7, wherein the image segmentation model is a student model that was generated based on a publicly available teacher model.

Embodiment 9. The method as recited in any of embodiments 1-8, wherein when the discriminator determines that the image received from the autonomous vehicle is another adversarial image, no image segmentation process is performed on the another adversarial image.

Embodiment 10. The method as recited in any of embodiments 1-9, wherein the perturbation in the adversarial image is created using a loss function that is combined with cross-entropy and a dissimilarity function.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

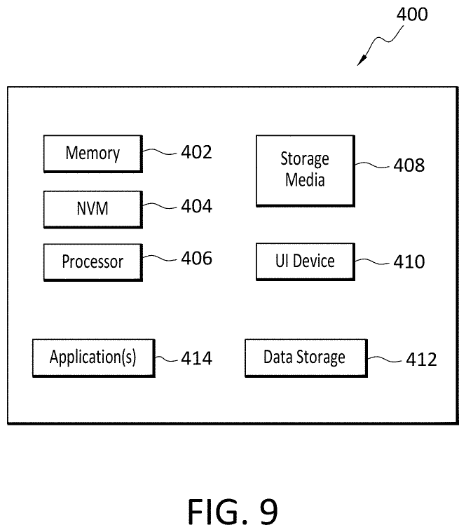

With reference briefly now to FIG. 9, any one or more of the entities disclosed, or implied, by FIGS. 1-8 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 9.

In the example of FIG. 9, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 402 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
deploying a discriminator, wherein the discriminator is trained to recognize an adversarial image received by the discriminator as adversarial, and wherein the adversarial image is generated based upon an original image, the adversarial image including a perturbation that cannot be detected by a human eye but which is effective to deceive an image segmentation model to misclassify the original image;
receiving, by the discriminator, an image captured by an autonomous vehicle; and
determining, by the discriminator, whether the image received from the autonomous vehicle is adversarial.

2. The method as recited in claim 1, wherein the adversarial image is generated using an optimized FGSM attack.

3. The method as recited in claim 2, wherein the adversarial image exhibits less perturbation than an adversarial image generated by a non-optimized FGSM attack.

4. The method as recited in claim 1, wherein when the image received from the autonomous vehicle is determined not to be adversarial, performing an image segmentation process on the image received from the autonomous vehicle, and the image segmentation process results in creation of image segments.

5. The method as recited in claim 4, wherein the autonomous vehicle uses the image segments to navigate.

6. The method as recited in claim 1, wherein the image segmentation model is a deep neural network model.

7. The method as recited in claim 1, wherein the discriminator uses a machine learning process to create the adversarial image.

8. The method as recited in claim 1, wherein the image segmentation model is a student model that was generated based on a publicly available teacher model.

9. The method as recited in claim 1, wherein when the discriminator determines that the image received from the autonomous vehicle is another adversarial image, no image segmentation process is performed on the another adversarial image.

10. The method as recited in claim 1, wherein the perturbation in the adversarial image is created using a loss function that is combined with cross-entropy and a dissimilarity function.

11. A computer readable storage medium having stored therein instructions that are executable by one or more hardware processors to perform operations comprising:
deploying a discriminator, wherein the discriminator is trained to recognize an adversarial image received by the discriminator as adversarial, and wherein the adversarial image is generated based upon an original image, the adversarial image including a perturbation that cannot be detected by a human eye but which is effective to deceive an image segmentation model to misclassify the original image;
receiving, by the discriminator, an image captured by an autonomous vehicle; and
determining, by the discriminator, whether the image received from the autonomous vehicle is adversarial.

12. The computer readable storage medium as recited in claim 11, wherein the adversarial image is generated using an optimized FGSM attack.

13. The computer readable storage medium as recited in claim 12, wherein the adversarial image exhibits less perturbation than an adversarial image generated by a non-optimized FSGM attack.

14. The computer readable storage medium as recited in claim 11, wherein when the image received from the autonomous vehicle is determined not to be adversarial, the operations further comprise performing an image segmentation process on the image received from the autonomous vehicle, and the image segmentation process results in creation of image segments.

15. The computer readable storage medium as recited in claim 14, wherein the autonomous vehicle uses the image segments to navigate.

16. The computer readable storage medium as recited in claim 11, wherein the image segmentation model is a deep neural network model.

17. The computer readable storage medium as recited in claim 11, wherein the discriminator uses a machine learning process to create the adversarial image.

18. The computer readable storage medium as recited in claim 11, wherein L u the image segmentation model is a student model that was generated based on a publicly available teacher model.

19. The computer readable storage medium as recited in claim 11, wherein when the discriminator determines that the image received from the autonomous vehicle is another adversarial image, no image segmentation process is performed on the another adversarial image.

20. The computer readable storage medium as recited in claim 11, wherein the perturbation in the adversarial image is created using a loss function that is combined with cross-entropy and a dissimilarity function.
